(19) United States
(12) Patent Application Publication
(10) Pub. No.: US 2014/0254612 A1
(43) Pub. Date: Sep. 11, 2014

(54) Method and filter for erasing hidden data

(71) Applicant: 4ULAB - AGNIESZKA PIOTROWSKA, Stare Babice (PL)

(72) Inventor: Agnieszka Piotrowska, Stare Babice (PL)

(21) Appl. No.: 13/868,153

(22) Filed: Apr. 23, 2013

(30) Foreign Application Priority Data
Mar. 7, 2013 (PL) P.403052

(51) Int. Cl. H04L 29/06

(52) U.S. Cl. CPC H04L 63/0227
USPC 370/474

(57) ABSTRACT

A method and a filter in telecommunication systems characterized in that the signal in the packet communications link is subject to normalization through restoration of default transport frame values, thus eliminating hidden data.

### BACKGROUND

The subject of the invention is a method and filter for erasing hiding data.

The subject of the application is from the field of steganography, i.e. transmission of data in covert communication channels.

In the art there are plenty of methods for hidden transmission of data. Hidden transmission channels are developed virtually in all layers of the OSI network model, starting from the physical layer, interfering directly with the physical parameters of signal, and ending with datagram layer, which transports the service contents, where hidden data transmission is implemented by using advanced hidden data introduction algorithms.

The Polish patent application PL 384940 describes a method in which the hidden data transmission is initiated with a transmission opening sequence and ended with a transmission closing sequence, and the information is sent from the transmitting station after an additional delay.

For instance, EP 1645058 A2 reveals a system of hiding data in audio transmission channels with phase modulation. The audio signal is divided into time frames. Relative phases of one or more frequency bands are shifted in each frame, and each shift represents embedded hidden data. In one example, two frequency bands are selected according to a pseudorandom sequence and then their relative phase is shifted.

The document U.S. Pat. No. 6,845,360 B2 describes systems and methods of embedding and extraction of plenty of messages in audio data. Each message contains a sequence of message symbols each comprising a combination of single-frequency components. At least some of the message symbols in one of the messages coexist with at least some of the symbols of another one of the messages along a time base of the audio data.

In the art there are series of methods to detect the presence of hidden transmission, however, in response to the attempts of detection, the development works aim at better hiding data transmission and masking the covert transmission channel.

Known solutions protecting against the use of hidden data transmission erase the hidden data, and are based on the fact of knowing the hidden data type or the data hiding algorithm. For instance, the patent application US 2007/0174766 A1 presents a method of hidden document data removal. The solution is based on a pre-defined configuration file which contains a set of rules and an inspection module which scans the the in search of sequences which correspond to the pre-defined rules, attempting to find a pre-defined data hidden with a method of comparing sequences.

However, the securing solutions based on the paradigm of knowing hidden data or data hiding algorithm face the obvious problem of plentifulness of possible steganographic algorithms. Furthermore, assuming that it is required to know the data hiding algorithm to secure the transmission channel means that the protection solutions will always be susceptible to the latest solutions and types of attacks for which the data embedding algorithm has not been yet discovered by the defending side.

However, having compared the known methods we can see some regularities. The first group of the methods includes employing unused header fields in network protocols. It is the easiest to implement but also the easiest to detect and filter out. Simple methods based on the use of fields such as ‘Padding’, ‘Type of Service’ in the IP header or the ‘Reserved’ field in the TCP header are described by S. Murdoch and S. Lewis in “Embedding covert channels into TCP/IP”. There are also solutions which create its own custom types of packets or frames to send hidden information. One such solution was described by Z. Piotrowski, K. Sawicki, M. Bednarczyk and P. Gajewski in their paper “New Hidden and Secure Data Transmission Method Proposal for Military IEEE 802.11 Networks”.

The second group, using modification of used fields in network protocols, includes more complicated methods. Since the information is hidden in used fields, it is necessary to ensure that once the information is hidden the protocol continues to function properly (inserted values must be correct from the point of view of the protocol). This often limits the throughput of the covert channel created in this manner. An example of such a covert channel is the one implemented using ‘Time to Live’ field in the IP header, as described in U.S. Pat. No. 7,415,018B2. Appropriate modification of fields makes it possible to send hidden messages in a way that does not interfere with the operation of the IP protocol. Another example is the use of the ‘Timestamp’ field in Beacon frames in wireless networks using the IEEE 802.11 standard, as described by K. Sawicki and Z. Piotrowski in the paper “The proposal of IEEE 802.11 network access point authentication mechanism using a covert channel”. In that solution, modification of the least significant bits of the ‘Timestamp’ field allows for transmission of hidden message and also does not interfere with the functioning of a wireless network. A model example of the use of some IEEE 802.11 frame fields and its practical application was described by L. Frikh, Z. Trabelsi and W. El-Hajj in “Implementation of a Covert Channel in the 802.11 Header”.

In some cases hidden data may be transmitted through modifications made to used header fields by damaging them on purpose. A typical system of that kind was described by K. Szczypiorski in the paper “HICCUPS Hidden communication system for corrupted networks”. It transmits data in IEEE 802.11 network frames with a deliberately corrupted checksum. A broad description of similar solutions has been presented by S. Li and A. Ephremides in the paper “Covert channels in ad-hoc wireless networks”.

The third group of methods uses intentional delay of sending or receiving of frame, datagram or packet, which allows transmission of hidden information through modification of time dependencies. A typical system of that kind was described by R. Holloway, R. Beyah in “Covert DCF: A DCF-Based Covert Timing Channel in 802.11 Networks”. The hidden information is transmitted by selecting an appropriate value of the ‘Backoff’ time chosen for each frame transmitted over a Wi-Fi network. This way, through intentionally delaying or accelerating the transmission of frames, it is possible to create a covert channel. A wide description of the methods is provided in the paper “TCP/IP timing channels: Theory to implementation” by S. H. Sellke, C. C. Wang, S. Bagchi and N. Shroff.

The fourth group are the methods which are based on intentional retransmissions or deliberate loss of transmitted data. A typical example of such a solution is the system described by W. Mazurczyk, M. Smolarczyk and K. Szczypiorski in the paper “Hiding information in re-transmissions”.

In the art, detection of hidden transmission was widely described by S. Cabuk, C. E. Brodley and C. S. Shields in the paper “IP covert channel detection”. The methods are considered to have 95% efficiency. Patented methods of detection of hidden transmissions are also available (U.S. Pat. No. 7,920,705B1). Such solutions require the use of advanced and continuously updated methods of analysis of the transmitted data. Furthermore, they do not guarantee detection of hidden channels created using the latest algorithms.

The solution to this problem may be to use the network steganography filter according to the invention.

In the art we cannot find a solution which would solely refer to the reverse process, i.e. the process of securing against the hidden data transmission. Furthermore, there is a need to introduce a method which would demonstrate equal efficiency in relation to the known algorithms of hiding covert transmission and be efficient as regards future methods of implementing data transmission in covert transmission channels.

### SUMMARY

What is disclosed is a method of filtering in telecommunication systems characterized by the fact that the signal in the packet communications channel is subject to normalization through restoration of default transport frame value, thus eliminating hidden data.

Furthermore, the method of the invention is characterized by the fact that normalization is implemented in relation to data in frame headers of the signal stream in the telecommunications channel.

In addition, the method of the invention is characterized by the fact that normalization is implemented in relation to checksums of frames through their re-calculation according to individual hash function.

Also, the method of the invention is characterized by the fact that normalization is implemented for at least one of the OSI model layers, preferably for all layers, and normalization process is controlled to ensure buffering to adjust delays between frames.

Further, the method of the invention is characterized by the fact that normalization is implemented for at least one frame, preferably for each frame of signal in the telecommunications channel.

Also, the method of the invention is that the signal in the telecommunications channel in the physical layer is subject to time-normalization through buffering and sending packets with uniform delay.

The advantage of the invention is introducing an efficient method of blocking covert data transmission channels irrespective of the applied method of embedding a covert data transmission channel into covert channels and irrespective of the method of packet protocol. The invention may be used on any transmission channel which uses packets as transport units. The invention enhances security of transmission in telecommunication networks and due to its universal application it may be used in multicast networks.

### DESCRIPTION OF THE DRAWING

The subject of the invention is presented in more detail, in a preferred embodiment in drawings of which:

FIG. 1 shows the normalization module, as described in the invention, of a single layer of packet protocol.

FIG. 2a shows the cascade normalization unit of many layers of packet protocol, as described in the invention.

FIG. 2b shows the sequence of normalization of layers in a cascade normalization unit of many layers, as described in the invention.

### DETAILED DESCRIPTION

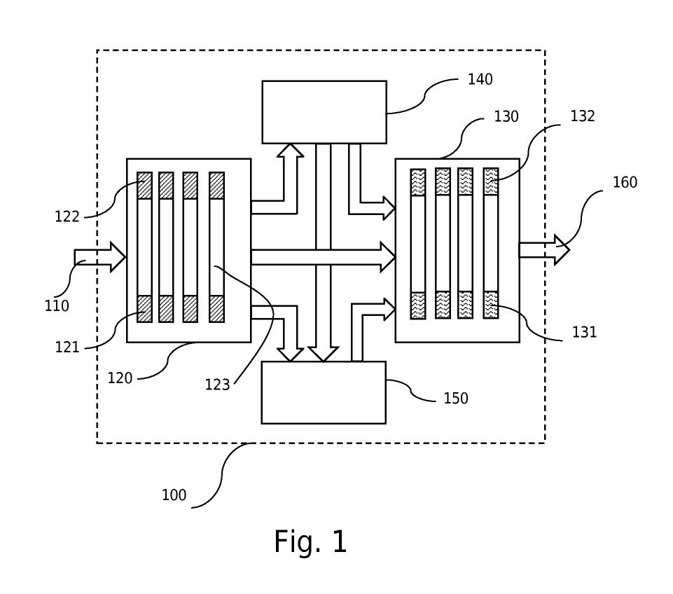

FIG. 1 shows the normalization module 100 of a single layer of packet protocol. The normalization module receives the input stream 110 made up of successive frames. The input stream is then transmitted to the separating module 120 which separates the header 122, the data field 123 and the frame end field 121 from the frame.

The header 122 separated in module 120 and/or the original frame received at the input are transmitted to the module 140 of the header normalization. In that module the header fields are restored to normalized values, i.e. either default values or values restored pursuant to the principles for a given layer of packet protocol.

The final frame field 121, separated in the module 120, and/or the original data field received at the input of the separating module 120 are sent to the module 150 of the final frame field normalization. Normalized header 132 is also sent to that module. In that module the final fields are restored to normalized values, i.e. either default values or values restored pursuant to the principles for a given layer of packet protocol. Particularly when final fields for a given layer of protocol contain checksums which are re-calculated for re-constructed frame.

The data field 123 separated in the module 120 is transmitted to the restoration module 130.

In the restoration module 130 the normalized header 132 and the normalized final frame field 131 are added to the data field 123.

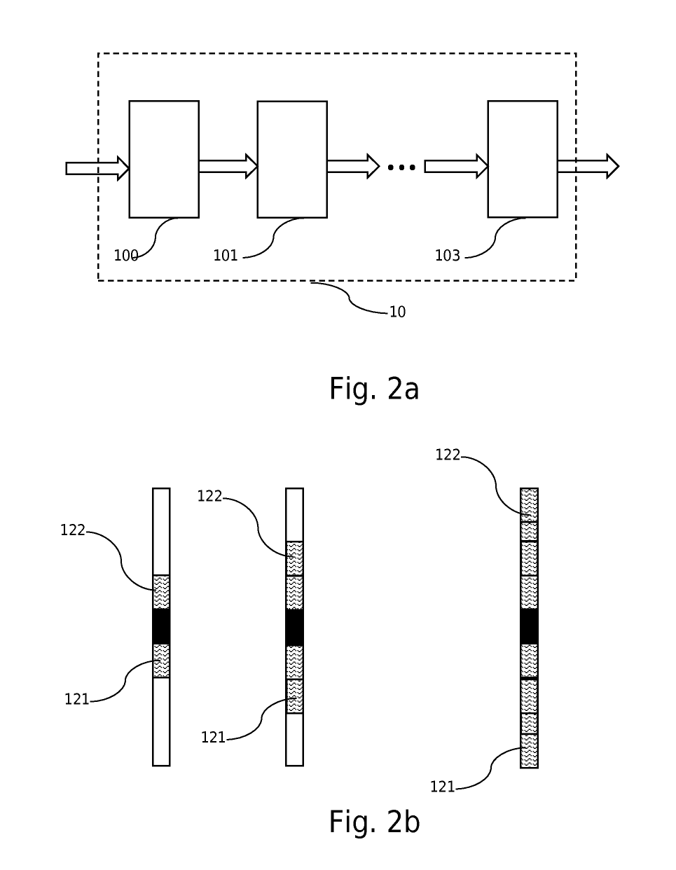

FIG. 2a shows cascade unit 10 of normalization of many layers of packet protocol, as described in the invention. The unit 10 includes a cascade of normalization modules (100, 101, 102) of a single packet protocol layer, such as the one presented in FIG. 1 above. Each module in unit 10 deals with normalization on a corresponding protocol layer. The number of normalization modules in a cascade may be freely selected depending on the needs as regards filtering of hidden transmission and acceptable delay caused by normalization.

It is worth noting here, that if the normalization also covers the normalization of final frame fields of a given layer, through re-calculation of checksums, then normalization shall be implemented first in relation to the layers which are embedded deepest, i.e. the highest layers of the OSI model covered by normalization.

FIG. 2b shows the sequence of normalization of layers in a cascade normalization unit of many layers, as described in the invention. It is visible that the normalization process in the cascade shown in FIG. 2a begins with the internal layers which are embedded deepest.

The filter of the invention may be used in many ways, including in particular placing the filter in devices such as a switch or a router, in the form of software and hardware modules. Software modules operating on higher layers of the OSI model have limited range depending on the configuration of the steganographic system, for instance when connection is established in point-to-point mode, without any intermediate devices. However, in a situation when we can interfere with the devices working in the lowest layer of the ISO/OSI models—in the physical layer, the filter may be also used there as well as the method of the present invention. This refers particularly to wireless networks such as Wi-Fi networks working in ad-hoc mode when the wireless transmission is realized directly from transmitter to receiver. Likewise, also the methods operating on the second layer of the ISO/OSI model—data link layer, may be filtered out that way.

As a consequence, the second possible way of using the filter of the invention, with access to the physical layer hardware, is building it into the final device (e.g. in a computer or a cellphone). Locating the filter of the invention in a module dealing with the receipt and transmission of data (e.g. in a network interface card) will enable filtering out hidden data before transmitting them to the operating system. There are no obstacles to implement the filter and the method of the invention on all or selected layers of the OSI model.

Furthermore, the normalization modules of the filter of the invention may implement simple normalization, for example, resetting the header fields values or the final frame fields, but also complex normalization, including the adaptation normalization or normalization including tracing of introduced modifications with use of change logs.

The example of such a function introduced for the normalization module 140 is normalization of the ‘Sequence number’ field in the TCP header. The filter must change that value so that the TCP transmission is successful. In the event that the modified value may occur in the future, a change log should be maintained where the information concerning the assignment of modified values will be stored.

Furthermore, the normalization modules 140 of the filter of the invention may be provided with additional functions allowing for broadening the area of filtration through implementing normalization of high degree of advancement, enabling to adjust the filter to a specific new type of steganographic transmission.

Further, the filter of the invention may also introduce adjustments of duration of the normalization and buffering of frames, thus affecting the delays occurring between subsequent frames, which enables eliminating the covert channel implemented with use of methods basing on time dependencies. For instance, in the event of methods based on intentional introduction of delays, the filter controls the normalization process in such a way that it randomly delays some frames or packets, or even modifies their sequence at random.

The filter of the invention may be also enhanced by an option of random losing or retransmission or frames, which introduces a disturbance to covert channel of data transmission and, therefore, greatly hinders or precludes the functioning of methods based on introduction of intentional retransmissions, delays and lost packets, by introducing normalized noise level.

The individual methods of normalization may be adjusted to the protocol of the covert channel and the filtration methods repository itself may be replaced or updated as necessary.

The effect obtained at the filter output thanks to normalization of fields is a uniform stream of data, normalized in time and space.

Thus, the filter of the invention can be an integral component of network and firewall hardware with Unified Threat Management Systems, as well as Intrusion Prevention Systems to enhance the real-time intrusion prevention efficiency. Filters of the invention may be also used in devices such as network switches, routers, network interface cards, which prevents from establishing and using hidden data transmissions on all layers of the OSI network model, including deep packet inspection.

1. A method of filtration in telecommunication systems
characterized in that
the signal on the packet telecommunications channel is subject to normalization by restoring the default values of the transport frame thus eliminating hidden data.

2. The method according to claim 1 wherein normalization is implemented to data in frame headers of the signal stream in the telecommunications channel.

3. The method according to claim 1 wherein normalization is implemented in relation to checksums of frames through their re-calculation according to individual hash function.

4. The method according to claim 1 wherein normalization is implemented for at least one of the OSI model layers, preferably for all layers, and the normalization process is controlled to ensure buffering to adjust delays between frames.

5. The method according to claim 1 wherein normalization is implemented for at least one frame, preferably for each frame of signal in the telecommunications channel.

6. The method according to claim 1 wherein the signal in the telecommunications channel in the physical layer is subject to time-normalization through buffering and sending packets with uniform delay.

7. A filter for telecommunication systems
characterized in that
it contains a module suitable for normalization of signal in the packet communication channel through restoring default values of the transport frame to eliminate hidden data.

8. The filter according to claim 7 wherein the filter module is suitable for normalization of data in frame headers of the signal stream in the telecommunications channel.

9. The filter according to claim 7 wherein the filter is suitable for normalization of checksums of frames through their re-calculation according to individual hash function.

10. The filter according to claim 7 wherein that the filter is suitable for normalization of at least one of the OSI model layers, preferably for all layers, however, the filter is suitable to control the normalization process in order to ensure buffering to adjust delays between frames.

11. The filter according to claim 7 wherein the filter is suitable for normalization of at least one frame, which is beneficial for each frame of signal in the telecommunications channel.

12. The filter according to claim 7 wherein the filter is suitable for time normalization of the signal in the telecommunications link in the physical layer through buffering and sending packets with uniform delay.
